(19) United States
(12) Patent Application Publication
(10) Pub. No.: US 2026/0078724 A1
(43) Pub. Date: Mar. 19, 2026

(54) GAS PROCESSING SYSTEMS WITH EMISSIONS QUANTIFICATION

(71) Applicant: Inpro/Seal LLC, Rock Island, IL (US)

(72) Inventors: Chad Stovell, San Antonio, TX (US); Colin Fish, San Antonio, TX (US); Ron Roth, San Antonio, TX (US); James Cole, Helotes, TX (US)

(21) Appl. No.: 19/327,465

(22) Filed: Sep. 12, 2025

Related U.S. Application Data
(60) Provisional application No. 63/694,468, filed on Sep. 13, 2024.

(51) Int. Cl. F02M 26/46; F02M 26/00; F02M 26/51

(52) U.S. Cl. CPC F02M 26/46; F02M 26/51; F02M 2026/003; F02M 2700/05

(57) ABSTRACT

A gas processing system comprises a compressor, an engine configured to drive the compressor, and a control system with emissions quantification capabilities. In some examples, one or more emissions lines direct leakage emissions from the compressor to the engine to be ingested as an alternate fuel source. One or more oxygen sensors generate oxygen sensor data indicating oxygen levels in an exhaust stream of the engine. The control system determines an actual air-fuel ratio of the exhaust stream based at least in part on the oxygen sensor data. The control system determines an error correction corresponding to an adjustment in the air-fuel mixture supplied to the engine to compensate for a difference between the actual air-fuel ratio and a commanded stoichiometric air-fuel ratio. The control system quantifies the leakage emissions from the compressor based at least in part on a comparison of the error correction to a baseline error correction.

### CROSS-REFERENCE TO RELATED APPLICATION

This application claims priority under 35 U.S. C. § 119 to U.S. Application Ser. No. 63/694,468, filed on Sep. 13, 2024, the contents of which is hereby incorporated by reference.

### TECHNICAL FIELD

This invention relates to gas processing systems with emissions quantification.

### BACKGROUND

In gas processing systems, engines are often used to drive gas compressors used for the transportation and processing of gases. These engines typically operate on a specific air-fuel ratio to ensure optimal performance and minimal emissions. However, leakage emissions from gas compressors, which are unintended leaks of gases, pose a significant challenge. These emissions not only contribute to environmental pollution but also represent a loss of valuable resources.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method performed by at least one processor.

The method also includes determining, based at least in part on oxygen sensor data, an actual air-fuel ratio (AFR) of an exhaust stream of an engine of a gas processing system. The oxygen sensor data is generated by one or more oxygen sensors arranged to detect oxygen levels in the exhaust stream. The engine is configured to drive a gas compressor of the gas processing system. The gas processing system can include one or more emissions lines configured to direct leakage emissions from the gas compressor to the engine to be ingested as an alternate fuel source.

The method also includes determining, based at least in part on a comparison of the actual AFR to a commanded stoichiometric AFR, an error correction corresponding to an adjustment in the air-fuel mixture supplied to the engine to compensate for a difference between the actual AFR and the commanded stoichiometric AFR.

The method also includes quantifying, based at least in part on a comparison of the error correction to a baseline error correction, the leakage emissions from the gas compressor. The baseline error correction corresponds to an expected adjustment in the air-fuel mixture supplied to the engine when the engine is not ingesting leakage emissions from the gas compressor. Various implementations include corresponding computer systems, apparatus, and computer programs recorded on one or more computer storage devices, each configured to perform the actions of the methods.

Implementations can include one or more of the following features. The processor(s) performing one or more of the actions of the methods includes a processor of an engine control module (ECM) of the gas processing system. The error correction is a closed-loop error correction. Performing the comparison between the actual AFR and the commanded stoichiometric AFR can include determining the difference between the actual AFR and the commanded stoichiometric AFR. Performing the comparison of the error correction to the baseline error correction can include determining a difference between the error correction and the baseline error correction. The method can include determining the baseline error correction during a length of time that occurs prior to determining the error correction. Determining the baseline error correction can include: commanding the engine to ingest fuel from a fuel source according to a first commanded stoichiometric AFR; determining, based on first oxygen sensor data from the one or more oxygen sensors, a first actual AFR of the exhaust stream of the engine when the exhaust stream is known to be a byproduct of the fuel ingested from the fuel source and not from leakage emissions from the gas compressor; and determining, based at least in part on a comparison of the first actual AFR to the first commanded stoichiometric AFR, the baseline error correction. Quantifying the leakage emissions from the gas compressor can be performed without the use of a flow meter.

The emissions line(s) can include a first emissions line for directing leakage emissions from a first component of the gas compressor to the engine, and a second emissions line for directing leakage emissions from a second component of the gas compressor to the engine. Quantifying the leakage emissions can include quantifying a first amount of gas emissions from the engine that is attributable to the first component of the gas compressor. The method can include quantifying a second amount of gas emissions from the engine that is attributable to the second component of the gas compressor. The method can include coordinating, in a controlled manner, respective open and closed states of a first valve of the first emissions line and a second valve of the second emissions line, such that leakage emissions from the first component and leakage emissions from the second component can be respectively quantified.

The method can include comparing the quantified leakage emissions to a threshold and, in response to determining that the quantified leakage emissions satisfies the threshold, triggering a notification. The threshold can be an excessive leakage threshold. The notification can be triggered in response to determining that the quantified leakage emissions meets or exceeds the excessive leakage threshold. The notification is indicative that one or more components of the gas compressor are leaking gas in excess of a predetermined amount of gas leakage. Implementations of the described techniques can include hardware, a method or process, or computer software on a computer-accessible medium.

In some aspects, a system includes: an engine configured to ingest fuel via one or more intake lines; a compressor coupled with the engine, where the engine is configured to drive the compressor; one or more emissions lines configured to direct leakage emissions from the compressor to the engine to be ingested as an alternate fuel source; one or more oxygen sensors configured to generate oxygen sensor data indicating oxygen levels in an exhaust stream of the engine; at least one processor communicably coupled to the one or more oxygen sensors; and memory communicably coupled to the at least one processor. The memory stores instructions, which, when executed, cause the at least one processor to perform operations including: determining, based at least in part on the oxygen sensor data, an actual air-fuel ratio (AFR) of an exhaust stream of the engine; determining, based at least in part on a comparison of the actual AFR to a commanded stoichiometric AFR, an error correction corresponding to an adjustment in the air-fuel mixture supplied to the engine to compensate for a difference between the actual AFR and the commanded stoichiometric AFR; and quantifying, based at least in part on a comparison of the error correction to a baseline error correction, the leakage emissions from the compressor. The baseline error correction corresponds to an expected adjustment in the air-fuel mixture supplied to the engine when the engine is not ingesting leakage emissions from the compressor. Various implementations include corresponding computer systems, apparatus, and computer programs recorded on one or more computer storage devices, each configured to perform the operations.

Implementations can include one or more of the following features. The engine and the compressor can be part of an integral engine-driven compressor package. The compressor can include a first component and a second component. The emissions line(s) can include a first emissions line for directing leakage emissions from the first component of the compressor to the engine, and a second emissions line for directing leakage emissions from the second component of the compressor to the engine. Quantifying the leakage emissions can include quantifying a first amount of gas emissions from the engine that is attributable to the first component of the compressor. The operations can include quantifying a second amount of gas emissions from the engine that is attributable to the second component of the compressor. The operations can include coordinating, in a controlled manner, respective open and closed states of a first valve of the first emissions line and a second valve of the second emissions line, such that leakage emissions from the first component and leakage emissions from the second component can be respectively quantified.

The compressor can include a first component and a second component. Leakage emissions from both the first component the second component can be routed together via a same emissions line of the emissions line(s) to the engine. The first component and/or the second component can include a rod packing seal or a pneumatic device. Implementations of the described techniques can include hardware, a method or process, or computer software on a computer-accessible medium.

In some aspects, a system includes: an engine configured to ingest fuel via one or more intake lines; a primary fuel source coupled with the engine via the one or more intake lines; a secondary fuel source coupled with the engine via the one or more intake lines; one or more oxygen sensors configured to generate oxygen data indicating oxygen levels in gas exhausted from the engine via one or more exhaust lines; and one or more processors.

The processors are configured to perform operations that include determining a first error correction for gas exhausted from the engine based on fuel ingestion from the primary fuel source and not from the secondary fuel source. The baseline error correction is determined based at least in part on a comparison between a first actual air-fuel ratio (AFR) and a first stoichiometric AFR. The first actual AFR is determined based at least in part on the oxygen data from the oxygen sensor(s). The operations further include determining, based at least in part on the oxygen data, a second actual AFR. The operations further include determining, based at least in part on a comparison between the second actual AFR and a second stoichiometric AFR, a second error correction different from the first error correction. The operations further include quantifying, based at least in part on a variance of the second error correction from the first error correction, at least one of: an amount of fuel from the secondary fuel source that was ingested by the engine; or an amount of gas emissions from the engine that is attributable to the secondary fuel source. Various implementations include corresponding computer systems, apparatus, and computer programs recorded on one or more computer storage devices, each configured to perform the operations.

Implementations can include one or more of the following features. The system can include a compressor driven by the engine. The secondary fuel source can include leakage emissions from the compressor. The system can include one or more emissions lines for directing the leakage emissions from the compressor to the one or more intakes lines. Implementations of the described techniques can include hardware, a method or process, or computer software on a computer-accessible medium.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 is a schematic block diagram of an example gas processing system that includes one or more control systems with emissions quantification capabilities, in accordance with some implementations.

FIG. 2 is a schematic block diagram of an example arrangement of an engine and a compressor that can be included in a gas processing system with emissions quantification capabilities, in accordance with some implementations.

FIG. 3 is a schematic block diagram of another example arrangement of an engine and a compressor that can be included in a gas processing system with emissions quantification capabilities, in accordance with some implementations.

FIG. 4 is a schematic block diagram of an example system that includes an engine with multiple fuel sources, and control system(s) with emissions quantification capabilities, in accordance with some implementations.

FIG. 5 is a flow chart that is representative of example methods of operating a gas processing system having emissions quantification capabilities, in accordance with some implementations.

FIG. 6 depicts an example computing system that can be included in a gas processing system with emissions quantification capabilities, in accordance with some implementations.

Like reference numbers in different figures indicate similar elements.

### DETAILED DESCRIPTION

In gas processing systems, engines are commonly used to drive gas compressors, which facilitate the transportation and processing of gases. These compressors are prone to unintended gas leaks, referred to as leakage emissions, which can include fuel, methane, and other pollutants. Such leaks can occur, for instance, through compressor components such as rod packing and pneumatic end devices. Regulatory bodies are increasingly emphasizing the need to monitor and control these leakage emissions. Mitigating and quantifying leakage emissions present significant challenges. For example, accurately measuring low-pressure, low-flow gas emissions can be challenging due to the high costs and limited availability of suitable flow meters, which are often not automated.

Various aspects of this disclosure relate to systems and methods for mitigating and/or quantifying such leakage emissions (e.g., without the use of flow meters). According to various implementations, a gas processing system includes an engine-driven gas processing unit (e.g., a compressor) and one or more control systems (e.g., including an engine control module (ECM)) with emissions quantification capabilities. Leakage emissions from the compressor can be captured and directed to the engine to be ingested as fuel (in effect, using the compressor an alternate fuel source), thereby mitigating the environmental impact of the leakage emissions.

The engine produces exhaust gases as a byproduct of the combustion process. One or more characteristics of the exhaust can be monitored using one or more sensors, which generate sensor data that is provided as feedback to the control system(s), e.g., in a closed-loop system. In various implementations, the control system(s) adjust fueling (e.g., by commanding a particular air-fuel ratio (AFR)) to the engine based at least in part on sensor(s) in the exhaust. The fueling adjustment can be referred to as a “closed-loop error correction” and/or an “adaptive correction.” Such corrections are also generally referred to herein as “error corrections.”

According to various implementations, the sensor(s) include oxygen sensor(s) configured to generate oxygen sensor data indicating oxygen levels in the exhaust, which information can be used to determine error corrections. The amount of error correction can vary based on whether or not the engine ingests leakage emissions from the compressor as fuel. By periodically feeding and not feeding the compressor's leakage emissions into the engine, the differential in error correction can be monitored and used as a basis for determining the quantity of leakage emissions from the compressor.

The term “air-fuel ratio” (AFR) refers to the ratio of the mass of air to the mass of fuel in the combustion mixture fed into the engine. The AFR affects the engine's performance, fuel efficiency, and emissions. The term “stoichiometric AFR” refers to the ideal ratio where all fuel is burned completely with all the available oxygen. In other words, the stoichiometric AFR is the chemically correct air-fuel ratio where there is just enough air to burn the fuel. The term “actual AFR” refers to the real-time ratio of the mass of fuel that is being supplied to the engine during operation. Unlike the stoichiometric AFR, which is a fixed ideal ratio, the actual AFR can vary depending on engine conditions, such as load, speed, and temperature. The actual AFR can be continuously adjusted by the control system(s) (e.g., by the ECM) to optimize performance, fuel efficiency, and emissions. The actual AFR can be measured using sensors such as the oxygen sensor(s) in the exhaust, which, as previously mentioned, provide feedback to the control system(s).

In the context of air-fuel ratios, phi (φ), also known as the equivalence ratio, is a dimensionless parameter that compares the actual AFR to the stoichiometric AFR. Phi is defined as the stoichiometric AFR divided by the actual AFR.

If phi is equal to one (1), this indicates a stoichiometric mixture, where the actual AFR is equal to the stoichiometric AFR.

If phi is less than one (1), this indicates a lean mixture, where the actual AFR is greater than the stoichiometric AFR. In a lean mixture, there is more air than is needed (and less fuel than is needed) in the mixture.

If phi is greater than one (1), this indicates a rich mixture, where the actual AFR is less than the stoichiometric AFR. In a rich mixture, there is more fuel than is needed (and less air than is needed) in the mixture.

Oxygen sensor data generated by oxygen sensor(s) placed in the exhaust can be used to determine actual AFR, which can be used to determine phi. On modern engines that are pre-mapped to have the correct air-fuel ratio, the phi commanded by an engine control module (ECM) will be nearly equal to the phi actually observed using the oxygen sensor(s). To account for minor errors in fuel metering or airflow from engine to engine, a small correction can be added to or subtracted from the fueling command, e.g., based on the error in measured phi (from the target phi) as observed from the oxygen sensor(s).

Any fuel added from an alternate source (not commanded by the ECM), such as the compressor's leakage emissions, would result in an error in the oxygen sensor phi reading, that is inversely proportional to the fueling command. By briefly cycling any added fuel from leakage emissions, the small amount of added fuel can be accurately measured by monitoring the fueling change on the ECM. If the fuel composition and load do not change over time, for example, error corrections determined based on the oxygen sensor data can be used to monitor and/or quantify leakage emissions without having to temporarily cycle the leakage emissions fueling on/off. Values can be tracked over time to show trends and excessive leaking from the compressor.

The emissions quantification capabilities described herein can be used to monitor the quantity of leakage emissions from the compressor generally and/or on a component-by-component basis, which can provide diagnostics regarding compressor health. In some implementations, notifications and/or alarms can be triggered if quantified leakage emissions satisfy one or more predetermined thresholds. For example, an excessive leakage threshold can be determined to be indicative of the compressor (and/or one or more particular components of the compressor) leaking gas in excess of an acceptable amount of gas leakage. The control system(s) can quantify the leakage emissions and compare the quantified leakage emissions to the excessive leakage threshold. In response to determining that the quantified leakage emissions meets or exceeds the excessive leakage threshold, a notification indicative that the gas compressor (and/or particular compressor component(s)) are leaking gas in excess of the predetermined acceptable amount of gas leakage is triggered. The control system(s) can cause the notification to be presented visually and/or audibly to an operator in some implementations.

Compressors are used as an example of an engine-driven gas processing unit throughout this disclosure, but it should be understood that various types of mechanical equipment that can be driven by an engine and that can leak gases (that are ingestible by the engine as fuel) can be examples of engine-driven gas processing units that are within the scope of this disclosure.

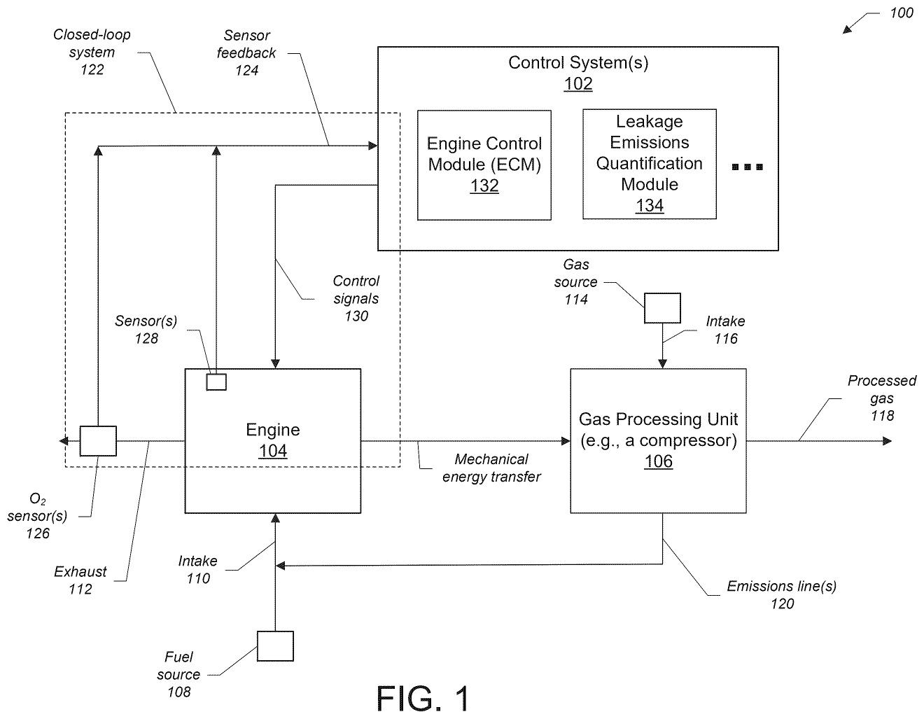

FIG. 1 is a schematic block diagram of an example gas processing system 100 that includes one or more control systems 102 with emissions quantification capabilities, in accordance with some implementations. The gas processing system 100 includes an engine 104 and a gas processing unit 106. The gas processing unit 106 is driven by the engine 104. The engine 104 is coupled with the gas processing unit 106 such that the engine 104 can transfer mechanical energy that drives the gas processing unit 106. The control system(s) 102 are configured to control operations of the engine 104 and/or the gas processing unit 106.

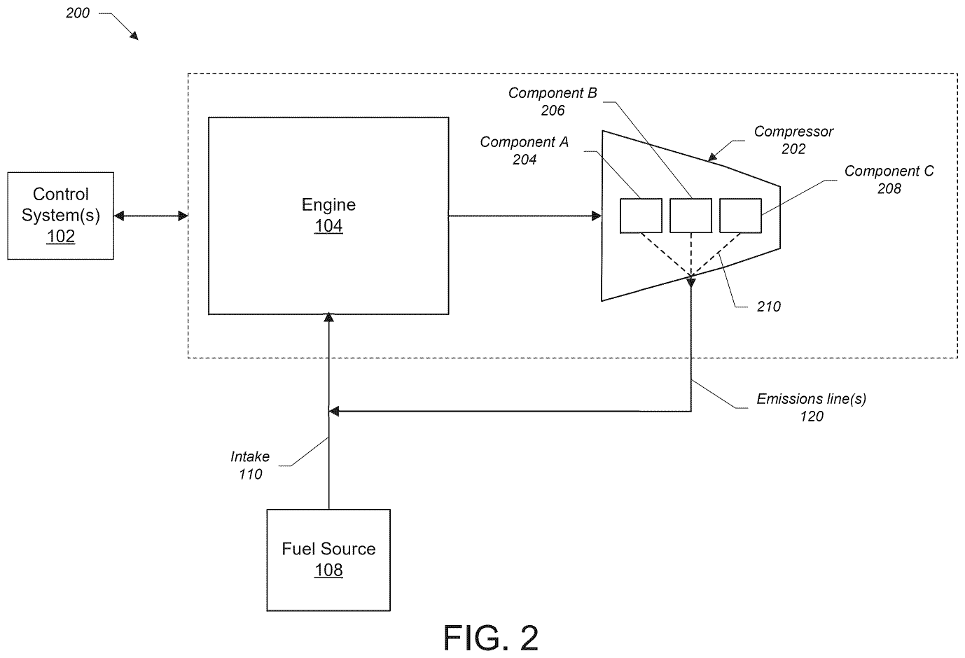

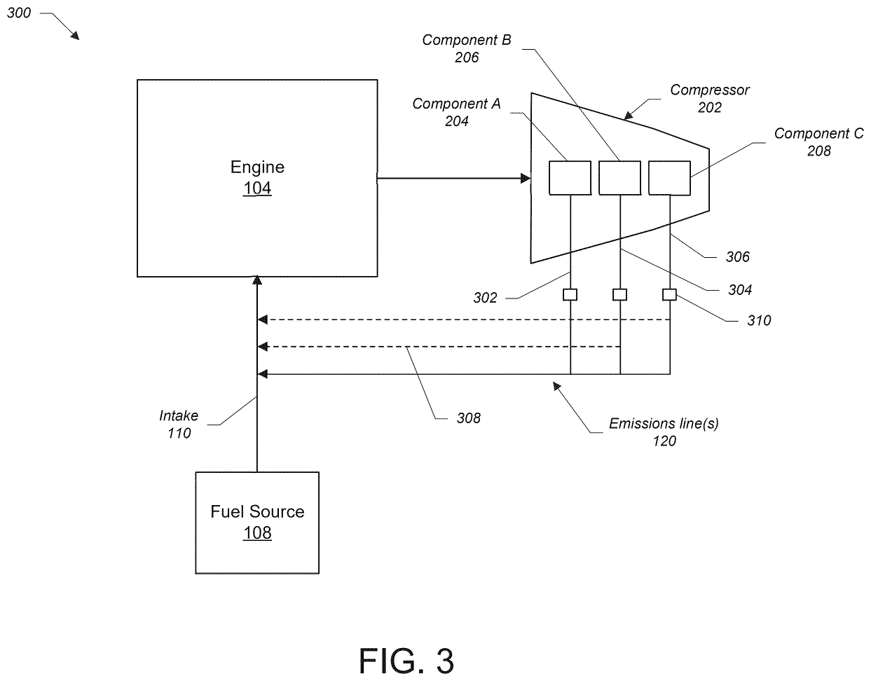

In various implementations, the gas processing unit 106 is a compressor (e.g., compressor 202 in FIGS. 2 and 3). For example, the compressor can be a positive displacement compressor (e.g., a rotary compressor such as a lobe compressor, screw compressor, scroll compressor or vane compressor, or a reciprocating compressor such as double acting compressor) or a dynamic compressor (e.g., a centrifugal or axial compressor).

The engine 104 is also coupled with a fuel source 108 via an intake 110. The engine 104 exhausts gases via exhaust 112 (e.g., comprising one or more exhaust streams).

The gas processing unit 106 is coupled with a gas source 114 via an intake 116. The gas processing unit 106 processes gas received from the gas source 114 and outputs processed gas 118. For example, in the case of the gas processing unit 106 being a compressor, the compressor is configured to compress the gas received from the gas source 114 and output compressed gas. As a non-limiting example, the gas processing system 100 can be used to transport gas through pipelines. The gas processing unit 106 can be a compressor that increases the pressure of the gas, enabling it to flow efficiently over long distances. This type of setup can maintain the steady supply of gas from production sites to end-users.

The gas processing unit 106 includes components that potentially leak gas received from the gas source 114. For example, gas compressor systems can vent gas(es) (e.g., fuel, methane, etc.) via leaks past rod packing, pneumatic end devices operated by gas, etc. In various implementations, these leakage emissions from the gas processing unit 106 are directed to the engine 104 to be ingested as an alternate fuel source. It should be noted that, as used herein, the term “alternate fuel source” can refer to the gas processing unit 106 (as the source of the leakage emissions being used as fuel) or to the leakage emissions (as providing fuel that is not from the fuel source 108). As indicated in FIG. 1, the gas processing system 100 can include one or more emissions lines 120 configured to convey leakage emissions from the gas processing unit 106 to the engine 104. In some implementations, the emissions line(s) 120 are coupled with the intake 110 to the engine 104. The particular manner in which the leakage emissions from the gas processing unit 106 are directed to the engine 104 can be different in other implementations. Where a single line is indicated in the figures for an intake/emissions line/exhaust/etc., it should be understood that some or all of such lines can represent multiple streams and/or different paths of streams in various implementations, depending on the context in which the gas processing system is being used.

In various implementations, the gas processing system 100 includes a closed-loop system 122 for providing sensor feedback 124 to the control system(s) 102, enabling the control system(s) to compare actual output(s) (e.g., an actual air-fuel ratio (AFR)) from the engine 104 and/or the gas processing unit 106 with the desired output(s) (e.g., a commanded stoichiometric AFR) and make adjustments (e.g., via error corrections) to compensate for when the actual output(s) vary from the desired output(s). In some implementations, the closed-loop system 122 includes one or more oxygen sensors 126 (e.g., at least partially disposed in exhaust 112) and/or one or more other sensors 128 (e.g., disposed in the engine and/or proximate the engine 104). The closed-loop system 122 further includes control signal(s) 130 from the control system(s) 102 to the engine 104 (and/or to the gas processing unit 106). For example, the control signal(s) 130 can include fuel commands, such as a commanded stoichiometric AFR and error corrections corresponding to adjustments in the air-fuel mixture supplied to the engine 104.

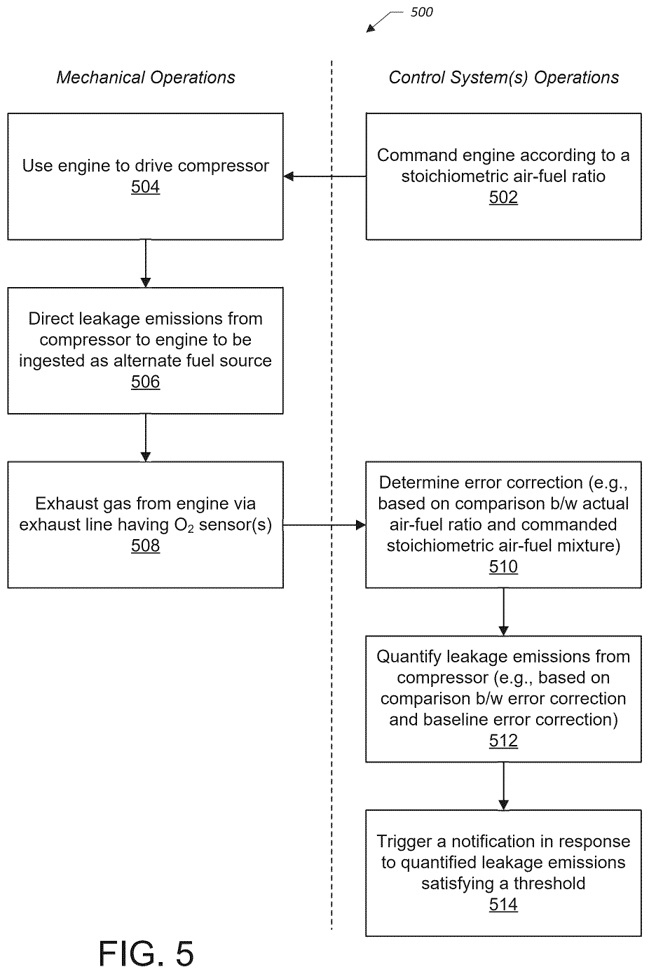

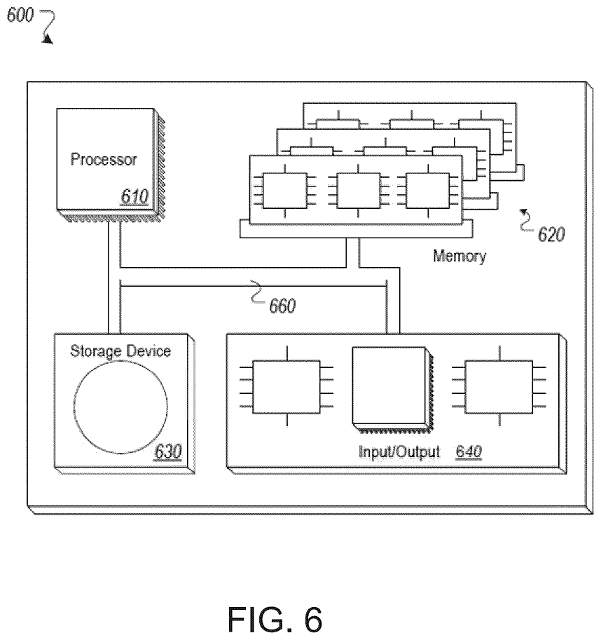

The control system(s) 102 can include an engine control module (ECM) 132, a leakage emissions quantification module 134, and/or one or more other modules. In FIG. 1, the ECM 132 and the leakage emissions quantification module 134 are shown as separate modules, but it should be understood that the leakage emissions quantification module 134 can be included in the ECM 132 in other implementations. For ease of discussion, the leakage emissions module 134 is generally referred to being part of the control system(s) 102. However, some or all of the functionality of the leakage emissions quantification module 134 can be implemented, for example, via software configured to run on one or more computing devices that are separate from the control system(s) 102 in which the ECM 132 resides, according to some implementations. The control system(s) can include memory (e.g., memory 620 in FIG. 6) and one or more processors (e.g., processor(s) 610 in FIG. 6). The ECM 132 and/or the leakage emissions quantification module 134 can comprise instructions stored in the memory. The processor(s) can execute the instructions to perform various operations. For example, the ECM 132 can include logic for monitoring and controlling various operational aspects of the engine 104. The leakage emissions quantification module 134 can include logic for quantifying leakage emissions from the gas processing unit 106, e.g., as discussed in further detail herein with reference to FIG. 5.

FIG. 2 is a schematic block diagram of an example arrangement 200 of an engine 104 and a compressor 202 that can be included in a gas processing system (e.g., gas processing system 100 in FIG. 1) with emissions quantification capabilities (e.g., via control system(s) 102), in accordance with some implementations.

In some implementations, the engine 104 and the compressor 202 are combined into a single, integrated unit (e.g., as an integral compressor package). In other implementations, the engine 104 and the compressor 202 are couplable with one another but can also be separated from one another if needed.

The compressor 202 includes multiple components. For example, as indicated in in the non-limiting example shown in FIG. 2, the compressor 202 includes component A 204, component B 206, and component C 208. These components represent compressor components that can leak gas. As indicated by dashed arrows 210, leaked gas from these components can be captured and conveyed to the engine's intake 110 via emissions line(s) 120. In the non-limiting example shown in FIG. 2, the dashed arrows 210 indicate that the leakage emissions from each of the components are combined into a single stream that is directed to the engine 104. However, as discussed herein with reference to FIG. 3, leakage emissions from each of the components can be directed to the engine 104 independently in some implementations.

FIG. 3 is a schematic block diagram of another example arrangement 300 of an engine 104 and a compressor 202 that can be included in a gas processing system (e.g., gas processing system 100 in FIG. 1) with emissions quantification capabilities (e.g., via control system(s) 102 in FIG. 1), in accordance with some implementations.

As indicated in FIG. 3, leakage emissions from individual components of the compressor 202 can have a respective path to the engine 104 without being combined in the emissions line(s) 120. For example, leakage emissions from component A 204 can be routed to the engine 104 via a respective path that includes line 302, emissions line(s) 120, other emissions line(s) 308, and/or intake 110. Leakage emissions from component B 206 can be routed to the engine 104 via a path that includes line 304, emissions line(s) 120, other emissions line(s) 308, and/or intake 110. Leakage emissions from component C 208 can be routed to the engine 104 via a path that includes line 306, emissions line(s) 120, other emissions line(s) 308, and/or intake 110. One or more valves 310 can be installed on one or more of these lines to control the flow of leakage emissions to the engine 104. While not shown in FIGS. 1, 2, and 4, the valve(s) 310 can similarly be used in various disclosed implementations.

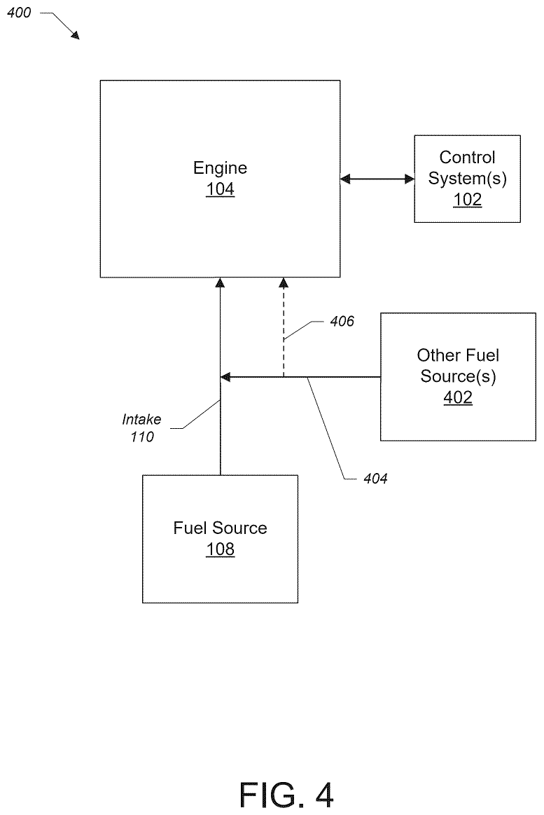

FIG. 4 is a schematic block diagram of an example system 400 that includes an engine with multiple fuel sources, and control system(s) 102 with emissions quantification capabilities, in accordance with some implementations. The fuel sources include fuel source 108 and one or more other fuel sources 402. In some non-limiting examples, fuel source 108 can be considered a “primary” or “default” fuel source that provides fuel to the engine 104, and the other fuel source(s) 402 can be considered “secondary” or “alternate” fuel sourc(es). A gas processing unit (e.g., gas processing unit 106 in FIG. 1 and/or compressor 202 in FIGS. 2 and 3, etc.) is a non-limiting example of such other fuel source(s) 402.

As indicated in FIG. 4, fuel from the other fuel source(s) (e.g., leakage emissions from a compressor) can be directed to the engine 104, e.g., via line 404, which can direct the fuel to intake 110 so that it can be fed into the engine 104. Additionally, or alternatively, the fuel from the other fuel source(s) can be directed to the engine from line 404 to line 406, which can form a path to the engine 104 separate from the intake 110.

FIG. 5 is a flow chart that is representative of an example method 500 of operating a gas processing system (e.g., gas processing system 100 in FIG. 1) having emissions quantification capabilities (e.g., via control system(s) 102 in FIG. 1), in accordance with some implementations. In FIG. 5, the operations to the left of the vertical dashed line generally pertain to mechanical operations (e.g., operations of the engine 104 and/or the gas processing unit 106 in FIG. 1, operations of the compressor 202 in FIG. 2, etc.) and the operations to the right of the vertical dashed line generally pertain to control system operation(s) (e.g., operations of the control system(s) 102 in FIG. 1). According to various implementations, the control system operation(s) can be performed by one or more processors.

At 502, the method 500 includes commanding an engine according to a stoichiometric air-fuel ratio (AFR). For example, the commanded stoichiometric AFR can be determined by an engine control module (ECM), such as ECM 132 in FIG. 1. The ECM can send control signals that cause the engine to intake fuel based on the commanded stoichiometric AFR.

At 504, the method 500 includes using the engine to drive a compressor (or otherwise a gas processing unit). The engine combusts the fuel to produce mechanical energy that is transferred to the compressor. For example, the engine can include a crankshaft and a connecting rod. The connecting rod can be coupled with the crankshaft. The compressor can include a piston that is coupled with the connecting rod. Such a series of mechanical linkages (e.g., the crankshaft, connecting rod, and piston) can be used to transfer mechanical energy from the engine to move the compressor's piston (which motion compresses gas in the compressor).

At 506, the method 500 includes directing leakage emissions from the compressor to the engine to be ingested as an alternate fuel source. At 508, the method 500 includes exhausting gas from the engine via exhaust line(s) having oxygen sensors at least partially disposed therein.

At 510, the method 500 includes determining an error correction (e.g., a closed-loop error correction). The error correction can be determined based at least in part on a comparison between an actual AFR and the commanded stoichiometric AFR. The error correction corresponds to an adjustment in the air-fuel mixture supplied to the engine to compensate for a difference between the actual AFR and the commanded stoichiometric AFR. The oxygen sensor data generated by oxygen sensor(s) placed in the exhaust can be used to determine the actual AFR.

At 512, the method 500 includes quantifying leakage emissions from the compressor. For example, the leakage emissions can be quantified based at least in part on a comparison between the error correction and a baseline error correction. The baseline error correction corresponds to an expected adjustment in the air-fuel mixture supplied to the engine when the engine is not ingesting leakage emissions from the compressor. For example, the baseline error correction can be determined during a length of time that occurs prior to determining the error correction. Determining the baseline error correction can include commanding the engine to ingest fuel from a fuel source according to a first commanded stoichiometric AFR; determining, based on first oxygen sensor data from the oxygen sensor(s), a first actual AFR of the exhaust stream when the exhaust stream is known to be a byproduct of the fuel ingested from the fuel source and not from leakage emissions from the compressor; and determining, based at least in part on a comparison of the first actual AFR to the first commanded AFR, the baseline error correction. In various implementations, quantifying the leakage emissions from the compressor is performed without the use of a flow meter.

In some examples, the emissions line(s) used to direct leakage emissions from the compressor to the engine include a first emissions line and a second emissions line. The first emissions line is used for directing leakage emissions from a first component of the compressor to the engine. The second emissions line is used for directing leakage emissions from a second component of the compressor to the engine. Quantifying the leakage emissions from the compressor can include quantifying a first amount of gas emissions from the engine that is attributable to the first component of the compressor and/or quantifying a second amount of gas emissions form the engine that is attributable to the second component of the compressor.

In various examples, the control operation(s) can further include coordinating, in a controlled manner, respective open and closed states of valves installed on the emissions line(s), such as valve(s) 310 in FIG. 3. The emissions quantification capabilities described herein can be used to monitor the quantity of leakage emissions from the compressor generally and/or on a component-by-component basis, which can provide diagnostics regarding compressor health.

At 514, the method 500 includes triggering a notification in response to determining that the quantified leakage emissions satisfy a threshold. In some implementations, a notification can be triggered if quantified leakage emissions satisfy one or more predetermined thresholds. For example, an excessive leakage threshold can be determined to be indicative of the compressor (and/or one or more particular components of the compressor) leaking gas in excess of an acceptable amount of gas leakage. The control system(s) can quantify the leakage emissions and compare the quantified leakage emissions to the excessive leakage threshold. In response to determining that the quantified leakage emissions meets or exceeds the excessive leakage threshold, a notification indicative that the gas compressor (and/or particular compressor component(s)) are leaking gas in excess of the predetermined acceptable amount of gas leakage is triggered. The control system(s) can cause the notification to be presented visually and/or audibly to an operator in some implementations.

Control system(s) and/or computing devices as described herein can include or use one or more computing systems. FIG. 6 depicts an example computing system 600 that can be included in a gas processing system with emissions quantification capabilities, in accordance with some implementations. The system 600 may be used for any of the operations described with respect to the various implementations discussed herein. The system 600 may include one or more processors 610, a memory 620, one or more storage devices 630, and one or more input/output (I/O) devices (not shown) controllable via one or more I/O interfaces 640. The various components 610, 620, 630, or 640 may be interconnected via at least one system bus 660, which may enable the transfer of data between the various modules and components of the system 600. In some implementations, a control system may be coupled to an operator display and/or control panel.

The processor(s) 610 may be configured to process instructions for execution within the system 600. The processor(s) 610 may include single-threaded processor(s), multi-threaded processor(s), or both. The processor(s) 610 may be configured to process instructions stored in the memory 620 or on the storage device(s) 630. For example, the processor(s) 610 may execute instructions for the various software module(s) described herein. The processor(s) 610 may include hardware-based processor(s) each including one or more cores. The processor(s) 610 may include general purpose processor(s), special purpose processor(s), or both.

The memory 620 may store information within the system 600. In some implementations, the memory 620 includes one or more computer-readable media. The memory 620 may include any number of volatile memory units, any number of non-volatile memory units, or both volatile and non-volatile memory units. The memory 620 may include read-only memory, random access memory, or both. In some examples, the memory 620 may be employed as active or physical memory by one or more executing software modules.

The storage device(s) 630 may be configured to provide (e.g., persistent) mass storage for the system 600. In some implementations, the storage device(s) 630 may include one or more computer-readable media. One or both of the memory 620 or the storage device(s) 630 may include one or more computer-readable storage media (CRSM). The CRSM may include one or more of an electronic storage medium, a magnetic storage medium, an optical storage medium, a magneto-optical storage medium, a quantum storage medium, a mechanical computer storage medium, and so forth. The CRSM may provide storage of computer-readable instructions describing data structures, processes, applications, programs, other modules, or other data for the operation of the system 600. In some implementations, the CRSM may include a data store that provides storage of computer-readable instructions or other information in a non-transitory format. The CRSM may be incorporated into the system 600 or may be external with respect to the system 600. The CRSM may include read-only memory, random access memory, or both. One or more CRSM suitable for tangibly embodying computer program instructions and data may include any type of non-volatile memory, including but not limited to: semiconductor memory devices, such as EPROM, EEPROM, and flash memory devices; magnetic disks such as internal hard disks and removable disks; magneto-optical disks; and CD-ROM and DVD-ROM disks. In some examples, the processor(s) 610 and the memory 620 may be supplemented by, or incorporated into, one or more application-specific integrated circuits (ASICs). The system 600 may include one or more I/O devices.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor may receive instructions and data from a read only memory or a random-access memory or both. Elements of a computer can include a processor for performing instructions and one or more memory devices for storing instructions and data. Generally, a computer may also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media, and memory devices, including by way of example semiconductor memory devices, e.g., EPROM, EEPROM, DRAM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A method performed by at least one processor, the method comprising:
determining, based at least in part on oxygen sensor data, an actual air-fuel ratio of an exhaust stream of an engine of a gas processing system, wherein the oxygen sensor data is generated by one or more oxygen sensors arranged to detect oxygen levels in the exhaust stream, wherein the engine is configured to drive a gas compressor of the gas processing system, and wherein the gas processing system comprises one or more emissions lines configured to direct leakage emissions from the gas compressor to the engine to be ingested as an alternate fuel source;
determining, based at least in part on a comparison of the actual air-fuel ratio to a commanded stoichiometric air-fuel ratio, an error correction corresponding to an adjustment in the air-fuel mixture supplied to the engine to compensate for a difference between the actual air-fuel ratio and the commanded stoichiometric air-fuel ratio; and
quantifying, based at least in part on a comparison of the error correction to a baseline error correction, the leakage emissions from the gas compressor, wherein the baseline error correction corresponds to an expected adjustment in the air-fuel mixture supplied to the engine when the engine is not ingesting leakage emissions from the gas compressor.

2. The method of claim 1, wherein the at least one processor comprises a processor of an engine control module (ECM) of the gas processing system.

3. The method of claim 1, wherein the error correction is a closed-loop error correction.

4. The method of claim 1, further comprising:
performing the comparison of the actual air-fuel ratio to the commanded stoichiometric air-fuel ratio, wherein the performing the comparison between the actual air-fuel ratio and the commanded stoichiometric air-fuel ratio comprises determining the difference between the actual air-fuel ratio and the commanded stoichiometric air-fuel ratio; and
performing the comparison of the error correction to the baseline error correction, wherein the performing the comparison of the error correction to the baseline error correction comprises determining a difference between the error correction and the baseline error correction.

5. The method of claim 1, further comprising determining the baseline error correction during a length of time that occurs prior to the determining the error correction.

6. The method of claim 5, wherein determining the baseline error correction comprises:
commanding the engine to ingest fuel from a fuel source according to a first commanded stoichiometric air-fuel ratio;
determining, based on first oxygen sensor data from the one or more oxygen sensors, a first actual air-fuel ratio of the exhaust stream of the engine when the exhaust stream is known to be a byproduct of the fuel ingested from the fuel source and not from leakage emissions from the gas compressor; and
determining, based at least in part on a comparison of the first actual air-fuel ratio to the first commanded stoichiometric air-fuel ratio, the baseline error correction.

7. The method of any claim 1, wherein the quantifying the leakage emissions from the gas compressor is performed without the use of a flow meter.

8. The method of claim 1, wherein:
the one or more emissions lines comprise:
a first emissions line for directing leakage emissions from a first component of the gas compressor to the engine; and
a second emissions line for directing leakage emissions from a second component of the gas compressor to the engine; and
the quantifying the leakage emissions comprises quantifying a first amount of gas emissions from the engine that is attributable to the first component of the gas compressor; and
the method further comprises quantifying a second amount of gas emissions from the engine that is attributable to the second component of the gas compressor.

9. The method of claim 8, further comprising:
coordinating, in a controlled manner, respective open and closed states of a first valve of the first emissions line and a second valve of the second emissions line, such that leakage emissions from the first component and leakage emissions from the second component can be respectively quantified.

10. The method of claim 1, further comprising:
comparing the quantified leakage emissions to a threshold; and
in response to determining that the quantified leakage emissions satisfies the threshold, triggering a notification.

11. The method of claim 10, wherein:
the threshold is an excessive leakage threshold;
the notification is triggered in response to determining that the quantified leakage emissions at least one of meets or exceeds the excessive leakage threshold; and
the notification is indicative that one or more components of the gas compressor are leaking gas in excess of a predetermined amount of gas leakage.

12. A system, comprising:
an engine configured to ingest fuel via one or more intake lines;
a compressor coupled with the engine, wherein the engine is configured to drive the compressor;
one or more emissions lines configured to direct leakage emissions from the compressor to the engine to be ingested as an alternate fuel source;
one or more oxygen sensors configured to generate oxygen sensor data indicating oxygen levels in an exhaust stream of the engine;
at least one processor communicably coupled to the one or more oxygen sensors; and
memory communicably coupled to the at least one processor, the memory storing instructions, which, when executed, cause the at least one processor to perform operations comprising:
determining, based at least in part on the oxygen sensor data, an actual air-fuel ratio of an exhaust stream of the engine;
determining, based at least in part on a comparison of the actual air-fuel ratio to a commanded stoichiometric air-fuel ratio, an error correction corresponding to an adjustment in the air-fuel mixture supplied to the engine to compensate for a difference between the actual air-fuel ratio and the commanded stoichiometric air-fuel ratio; and
quantifying, based at least in part on a comparison of the error correction to a baseline error correction, the leakage emissions from the compressor, wherein the baseline error correction corresponds to an expected adjustment in the air-fuel mixture supplied to the engine when the engine is not ingesting leakage emissions from the compressor.

13. The system of claim 12, wherein the engine and the compressor are part of an integral engine-driven compressor package.

14. The system of claim 12, wherein:
the compressor comprises:
a first component; and
a second component; and
the one or more emissions lines comprise:
a first emissions line for directing leakage emissions from the first component of the compressor to the engine; and
a second emissions line for directing leakage emissions from the second component of the compressor to the engine.

15. The system of claim 14, wherein:
the quantifying the leakage emissions comprises quantifying a first amount of gas emissions from the engine that is attributable to the first component of the compressor; and
the operations further comprise quantifying a second amount of gas emissions from the engine that is attributable to the second component of the compressor.

16. The system of claim 14, wherein the operations further comprise:
coordinating, in a controlled manner, respective open and closed states of a first valve of the first emissions line and a second valve of the second emissions line, such that leakage emissions from the first component and leakage emissions from the second component can be respectively quantified.

17. The system of claim 12, wherein:
the compressor comprises:
a first component; and
a second component; and
leakage emissions from both the first component the second component are routed together via a same emissions line of the one or more emissions lines to the engine.

18. The system of claim 14, wherein the first component comprises:
a rod packing seal; or
a pneumatic device.

19. A system, comprising:
an engine configured to ingest fuel via one or more intake lines;
a primary fuel source coupled with the engine via the one or more intake lines;
a secondary fuel source coupled with the engine via the one or more intake lines;
one or more oxygen sensors configured to generate oxygen data indicating oxygen levels in gas exhausted from the engine via one or more exhaust lines;
one or more processors configured to:
determine a first error correction for gas exhausted from the engine based on fuel ingestion from the primary fuel source and not from the secondary fuel source, the baseline error correction being determined based at least in part on a comparison between a first actual air-fuel ratio and a first stoichiometric air-fuel ratio, the first actual air-fuel ratio being determined based at least in part on the oxygen data from the one or more oxygen sensors;
determine, based at least in part on the oxygen data, a second actual air-fuel ratio;
determine, based at least in part on a comparison between the second actual air-fuel ratio and a second stoichiometric air-fuel ratio, a second error correction different from the first error correction;
quantify, based at least in part on a variance of the second error correction from the first error correction, at least one of:
an amount of fuel from the secondary fuel source that was ingested by the engine; or
an amount of gas emissions from the engine that is attributable to the secondary fuel source.

20. The system of claim 19, further comprising:
a compressor driven by the engine, wherein the secondary fuel source comprises leakage emissions from the compressor; and
one or more emissions lines for directing the leakage emissions from the compressor to the one or more intakes lines.
